(19) United States
(12) Patent Application Publication
(10) Pub. No.: US 2011/0138951 A1
(43) Pub. Date: Jun. 16, 2011

(54) WIND TURBINE WITH GEAR INDICATING WEAR

(75) Inventors: Aaron John Mashue, Simpsonville, SC (US); James Warren Pemrick, Troy, NY (US)

(73) Assignee: General Electric Company

(21) Appl. No.: 12/891,912

(22) Filed: Sep. 28, 2010

(51) Int. Cl. F16H 55/08; F16H 1/00

(52) U.S. Cl. 74/457; 74/640

(57) ABSTRACT

A wind turbine is provided having a tower, a nacelle supported by the tower and a rotor with one or more blades and a hub. A gearbox is connected to the rotor and includes one or more gears having a wear indicating line that facilitates identification of gear wear. The wear indicating lines are located on side surfaces of the one or more gears.

### BACKGROUND OF THE INVENTION

The apparatus described herein relates generally to a wind turbine. More specifically, the apparatus relates to a wind turbine having a gear with a wear indicator.

Recently, wind turbines have received increased attention as environmentally safe and relatively inexpensive alternative energy sources. Wind turbines do not emit greenhouse gases (GHGs), and therefore, do not contribute to global warming. With the growing interest in wind generated electricity, considerable efforts have been made to develop wind turbines that are reliable and efficient.

Wind is usually considered to be a form of solar energy caused by uneven heating of the atmosphere by the sun, irregularities of the earth's surface, and rotation of the earth. Wind flow patterns are modified by the earth's terrain, bodies of water, and vegetation. The terms wind energy or wind power, describe the process by which the wind is used to rotate a shaft and subsequently generate mechanical power or electricity.

Typically, wind turbines are used to convert the kinetic energy in the wind into mechanical power. This mechanical power may be used for specific tasks (such as grinding grain or pumping water) or a generator may convert this mechanical power (i.e., the rotation of a shaft) into electricity. A wind turbine usually includes an aerodynamic mechanism (e.g., blades) for converting the movement of air into a mechanical motion (e.g., rotation), which is then converted with a generator into electrical power. Power output from the generator is proportional to the cube of the wind speed. As wind speed doubles, the capacity of wind generators increases almost eightfold.

The majority of commercially available wind turbines utilize geared drive trains to connect the turbine blades to the electrical generators. The wind turns the turbine blades, which spin a low speed shaft, which feeds into a gearbox having a higher speed output shaft. This higher speed output shaft connects to a generator and makes electricity. The geared drive aims to increase the velocity of the mechanical motion.

The industry standard drive train for large (e.g., >1.5 MW) wind turbines consists of discrete gearbox and generator units that are separately mounted to a mainframe (also commonly called a bedframe or bedplate). Power is transferred from the gearbox to the generator via a flexible “high-speed” shaft coupling. This arrangement forces the gearbox and generator to be physically distanced from each other, as well as, requires both the output shaft of the gearbox and the input shaft of the generator to be separately supported by gearbox bearings and generator bearings, respectively.

### BRIEF DESCRIPTION OF THE INVENTION

In an aspect of the present invention, a wind turbine is provided having a tower, a nacelle supported by the tower and a rotor with one or more blades and a hub. A gearbox is connected to the rotor and includes one or more gears having at least one wear indicating line that facilitates identification of gear wear. The wear indicating line is located on side surfaces of the gears.

In another aspect of the present invention, a gearbox for a wind turbine is provided having one or more gears with wear indicating lines that facilitate identification of gear wear. The wear indicating lines are located on side surfaces of the gears.

### BRIEF DESCRIPTION OF THE DRAWINGS

FIG. 1 is a perspective illustration of an exemplary wind turbine;

FIG. 2 is a partial, cut-away perspective illustration of one embodiment of a drive train that can be used in the wind turbine of FIG. 1;

FIG. 3 is a partial, side illustration of a gear having wear indicating lines, according to an aspect of the present invention;

FIG. 4 is a cross-sectional illustration of a gear tooth having wear indicating lines, according to an aspect of the present invention;

FIG. 5 is a cross-sectional illustration of a gear tooth having wear indicating lines, according to an aspect of the present invention;

FIG. 6 is a partial, side illustration of a gear having wear indicating lines, according to an aspect of the present invention;

FIG. 7 is a partial, side illustration of a gear having wear indicating lines, according to an aspect of the present invention;

FIG. 8 is a partial, side illustration of a gear having wear indicating lines, according to an aspect of the present invention;

FIG. 9 is a partial, side illustration of a gear having wear indicating lines, according to an aspect of the present invention; and

FIG. 10 is a cross-sectional illustration of a gear tooth having wear indicating lines, according to an aspect of the present invention.

### DETAILED DESCRIPTION OF THE INVENTION

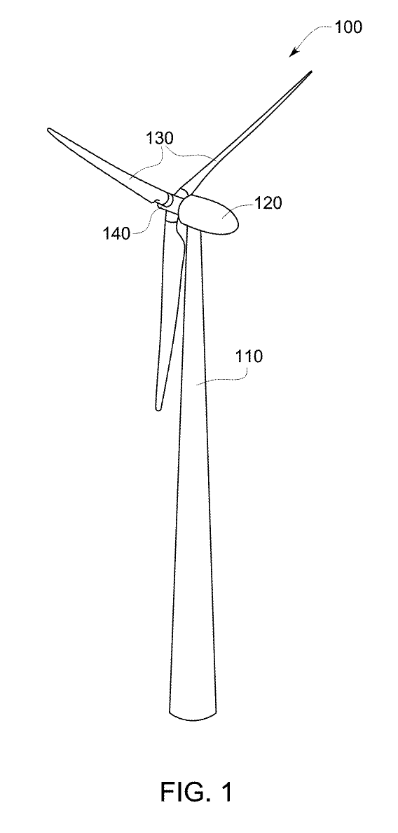

A horizontal axis wind turbine (HAWT) 100 is illustrated in FIG. 1. The wind turbine 100 may include a generally tubular tower 110, which may be manufactured of steel, concrete or combinations thereof. The tower 110 may be erected by stacking multiple tower segments on top of each other. The tower 110 supports the weight of the nacelle 120, blades 130 and hub 140. Tower 110 may also be of the lattice (or truss) type, and may alternatively be formed of concrete or concrete sections. The nacelle 120 typically houses the drive train (e.g., gearbox, shafts, couplings, generator, etc.), as well as the main frame (also called bedplate) and yaw drives. Other items such as the control electronics may be housed within the nacelle 120 as well. Typically, the nacelle 120 will have an outer skin that is comprised of a lightweight material such as fiberglass or a graphite composite. The main function of the nacelle skin is to protect the contents from the elements (e.g., rain, ice, snow, etc.).

The blades 130 are connected to the hub 140, and the hub may contain a pitch control mechanism to control the pitch angle of each blade. Typically, three blades are employed in most commercial wind turbines, however, one, two or four or more blades could be employed as well. The blades convert the kinetic energy of the wind into mechanical energy by rotating a low speed shaft. Blades may be manufactured from fiberglass or graphite composites, fiberglass reinforced plastics or wood/epoxy laminates, or other suitable materials. The low speed shaft is connected to the hub 140 typically via a bolted flange coupling.

Generators are used to convert the rotation of a shaft into electrical energy. A gearbox is typically used to increase the speed of the input shaft to the generator. The gearbox has the low speed shaft as its input, and the output is a higher speed shaft, which according to aspects of the present invention, can feed directly into the generator.

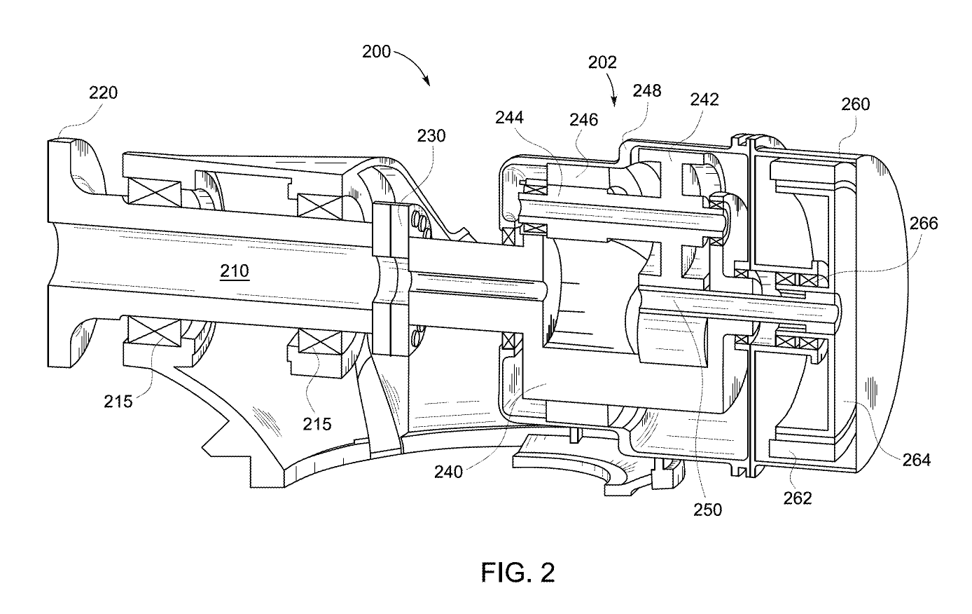

FIG. 2 illustrates a drive train 200 comprising a compound planetary gearbox 202 and generator 260. The low speed shaft 210 is supported by two separate and axially spaced main bearings 215. The low speed shaft 210 is connected via hub flange mount 220 to the hub 140 and blades 130 of wind turbine 100. Accordingly, low speed shaft 210 is driven by the wind turning blades 130. The low speed shaft 210 is connected to planet carrier 240 through a torque transmitting coupling 230. The planet carrier 240 supports the planet gears 242 and planet pinion gears 244, which share a common shaft. A ring gear 246 is fixedly attached to gearbox housing 248 and meshes with the planet pinion gears 244. A sun gear 250 is driven by the planet gears 242, and the output of the sun gear 250 is fed directly into generator 260. The generator 260 has a stator 262 and a rotor 264. The rotor 264 is supported by rotor bearings 266, which are enclosed within the generator 260.

The gearbox 202 may be any suitable type of gearbox including, but not limited to parallel-shaft gearboxes and planetary gearboxes. The gearbox may have, one, two, three or more stages, although for a large wind turbine three or fewer stages are preferred. The individual gears (e.g., low speed shaft gear, high speed shaft gear, sun gear, planetary gear, ring gear, etc.) include a number of teeth that engage the teeth of adjacent gears. For example, the teeth on sun gear 250 engage the teeth on planetary gear 242.

During operation of the wind turbine, the gears of the gearbox 202 can experience wear. It is important to monitor this wear and repair or replace any gears that are out of specification. However, to date it has been difficult to determine how much wear has occurred on the gears. One known solution has required a technician to use a template where the gear impression was machined in and then the gap between the template and the gear tooth would be measured using feeler gauges. However, this process can return variable results based on the specific technician performing the measurement.

An improved gear 300 is illustrated in FIG. 3, which is a partial, simplified side view of a gear which may be used in the gearbox of a wind turbine. The gear 300 includes a plurality of teeth 310, only three of which are shown. The teeth 310 are arranged circumferentially around the gear 300. One or more wear indicating lines 320 can be arranged along all or a portion of the surface of the gear 300. In FIG. 3, the wear indicating lines are arranged a predetermined distance D away from the tooth surface, and on both sides of each tooth 310.

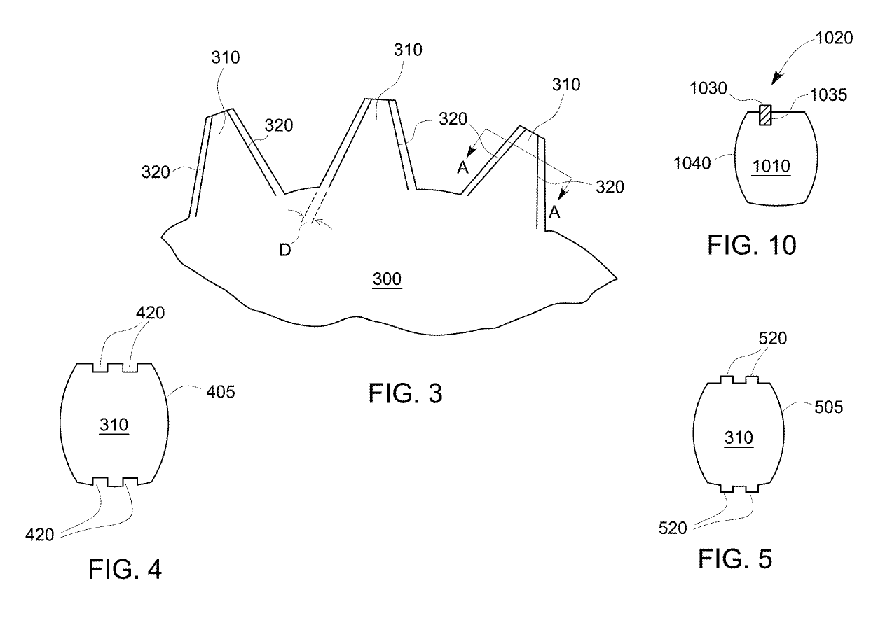

The wear indicating lines can be recessed into the gear surface and be formed by grooves or inscribed lines. FIG. 4 illustrates a cross-sectional view of gear 300 along cross-section A-A of FIG. 3, where the wear indicating lines are comprised of grooves 420. The grooves 420 can be recessed from the bearing surface 405 of tooth 310 by a predetermined distance D that indicates undesirable wear. The grooves 420 may be formed by continuous grooves or may include segmented regions that are flush with the side of the gear tooth. In this instance, grooves 420 would take the form of a “dotted line” or segmented groove, and this may be desirable as it could facilitate the viewing of groove 420 by a technician during an inspection process. Gearboxes are typically filled with lubricant which can fill grooves 420, so a segmented groove may make it easier for a technician to view the wear indicating lines as there will be greater contrast between the grooved and un-grooved portions of wear indicating line 420.

However, in some applications it may be desirable to have wear indicating lines protrude from the gear surface. FIG. 5 illustrates a cross-sectional view of tooth 310 along section line A-A of FIG. 3. The wear indicating line 520 is comprised of a raised rib that protrudes from the remaining side surface of tooth 310. The raised rib wear indicating line 520 can be recessed from the bearing surface 505 of tooth 310 by a predetermined distance D that indicates undesirable wear. The wear indicating line 520 may be formed by a continuous rib or may include segmented regions that alternately protrude from or are flush with the side of the gear tooth.

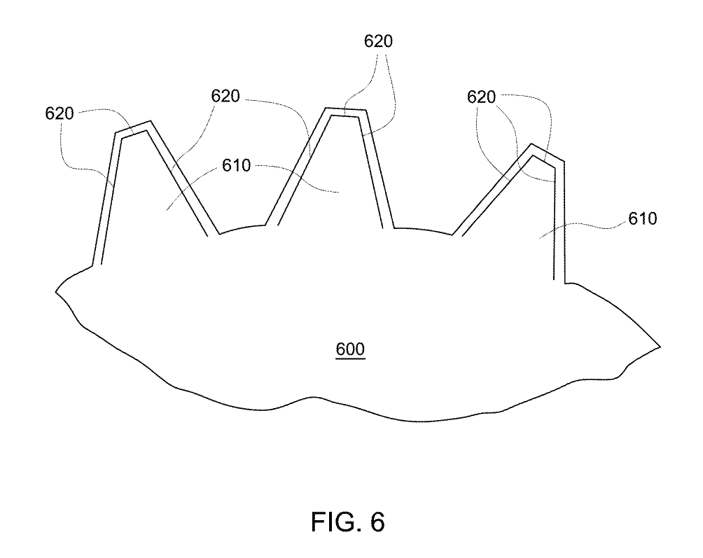

FIG. 6 illustrates a partial side view of a gear 600 having wear indicating lines 620 extend along the top and side portions of teeth 610. If the surface of the gear tooth 610 wears below this line 620, it would be readily visible during an inspection. A technician could then either repair or replace the worn gear or gears.

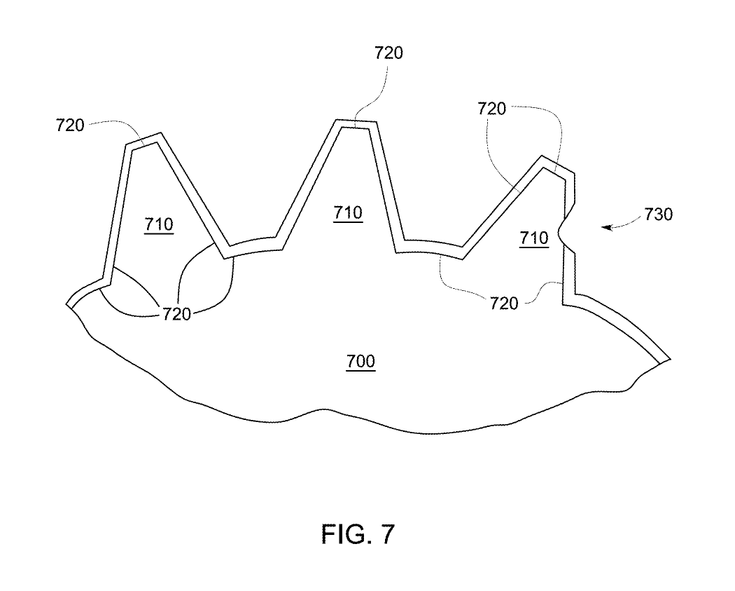

FIG. 7 illustrates a partial side view of a gear 700 having wear indicating lines 720 extend along the top and side portions of teeth 710 as well as the intervening portions between teeth. A damaged region or worn region 730 is present on one of the teeth and can be readily identified by comparing it to wear indicating line 720. A technician can quickly and easily compare gear and tooth surfaces against wear indicating lines 720 to determine if the gear is undesirably worn or is in need of repair or replacement.

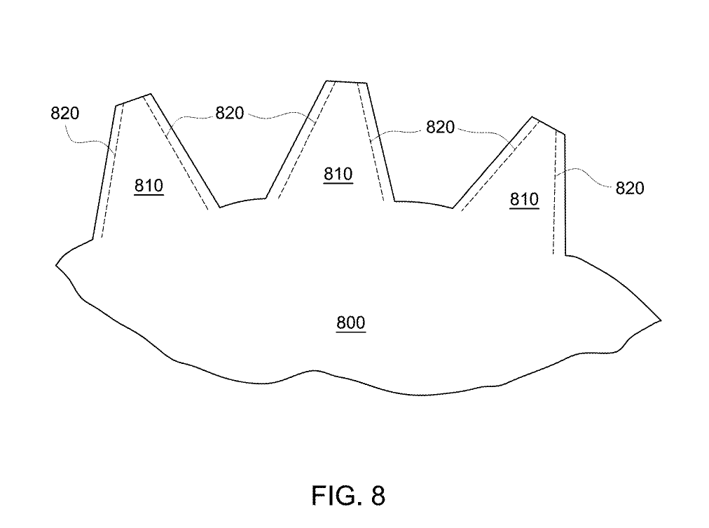

FIG. 8 illustrates a partial side view of a gear 800 having segmented wear indicating lines 820 extend along the side portions of teeth 810. The segmented wear indicating lines 820 may be formed by alternating line regions that are flush with the side of the tooth 810 and regions that protrude from and/or are recessed into the side gear surface. In one example, a raised rib portion of line 820 could alternate between flush portions along the side of tooth 810. In another example a recessed groove portion of line 820 could alternate between flush portions along the side of tooth 810. In another example, a combination of flush, raised and recessed portions of line 820 could be used to help a technician visually detect the wear indicating line 820 and compare it to the gear or tooth surface.

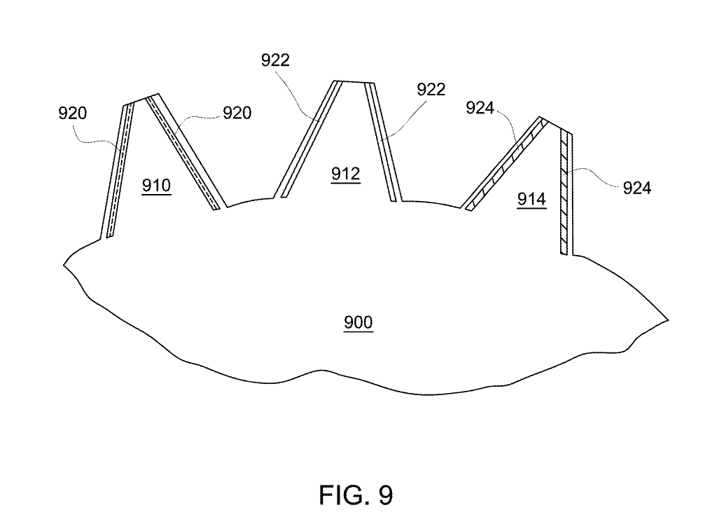

FIG. 9 illustrates a side view of a gear 900 having a different types of wear indicating lines. In most applications one type of wear indicating line will be used on a gear, but it may be desired to use multiple types of wear indicating lines in various positions on the gears or teeth. Tooth 910 includes wear indicating lines 920 that have a roughened surface. Tooth 912 includes wear indicating lines 922 that have a polished or reflective surface. Tooth 914 includes wear indicating lines 924 that are comprised of a magnetic material.

The roughened surface wear indicating line 920 can provide good contrast between the line 920 and nearby portions of the tooth 910 or gear 900. As most gears will have a coating of lubricant (e.g., oil), the roughened surface will tend to retain more lubricant than the surrounding smooth surfaces. Even if a technician wipes a side surface of tooth 910, the roughened surface will “stand out” compared to non-roughened portions of tooth 910.

The polished or reflective surface wear indicating line 922 can also provide good contrast between the line 922 and nearby portions of the tooth 912 or gear 900. As most gears will have a coating of lubricant (e.g., oil), the polished or reflective surface will tend to retain less lubricant than the surrounding side surfaces of tooth 912. The polished and/or reflective surface of line 922 will “stand out” compared to “rougher” portions of tooth 912. The wear indicating line 922 could also be formed of a fluorescent or phosphorescent ink/material. This could help “illuminate” the line under low light conditions or with the use of specific lighting sources (e.g., a Wood's lamp or black light).

The magnetic surface wear indicating line 924 can facilitate differentiating between the line 924 and nearby portions of the tooth 914 or gear 900. The magnetic surface can be easily located with a magnetic probe. The magnetic surface may also retain small particles that will contrast with the non-magnetic surrounding side surfaces of tooth 914.

FIG. 10 illustrates a cross-sectional view of a gear tooth 1010 having a wear indicating line 1020 comprised of an elastomeric material insert 1030 secured within a groove 1035. The “raised rib” effect would facilitate location of and viewing of the wear indicating line 1020, as well as the comparison of the wear indicating line 1020 to the bearing surface 1040 of the tooth surface. The elastomeric material 1030 could be any suitable material, and one example would be a rubber material or rubber composite. The groove 1035 could be rectangular or have a dovetail shape, or any other suitable shape as desired in the specific application.

The wear indicating line can be placed on one or both sides of the gears and or teeth, and each side can have one or more wear indicating lines. Typically, at least one side of the gear will have at least one wear indicating line. The wear indicating line can be spaced inward from the wearable surfaces of the gear by a predetermined amount that indicates undesirable wear on the gear and/or tooth surface. The wear indicating line can also be formed of a combination of a recessed groove, a raised rib, a roughened surface, a polished surface, a reflective surface, fluorescent material, phosphorescent material and/or a magnetic material, or any combinations thereof. As one example only, the wear indicating line could be formed of a grooved portion, a raised rib portion, a roughened surface portion and a magnetic material portion.

The wear indicating lines can also be used with optical devices and processing systems that image the gears or portions thereof, and then calculate the amount of wear or estimate the remaining amount of gear life. The contrasting surfaces of the wear indicating lines facilitate manual or electronic identification and location of the wear indicating lines, and subsequent evaluation of wear experienced by the gears and/or gear teeth.

One preferred generator type that can be used with the wind turbine of the present invention is a PM synchronous generator, but induction generators, wound-field synchronous generators, or doubly-fed asynchronous generators could be used as well. A wind turbine employing a single generator has been described, but it is to be understood that multiple generators could also be used with modifications to the gearbox. In addition, it is to be understood that the wear indicating line(s) of the present invention could be used in any application where an indication of gear wear is desired.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A wind turbine comprising:
a tower;
a nacelle supported by the tower;
a rotor comprising one or more blades and a hub;
a gear box connected to the rotor, the gearbox comprising one or more gears having at least one wear indicating line that facilitates identification of gear wear;
wherein the at least one wear indicating line is located on side surfaces of the one or more gears.

2. The wind turbine of claim 1, further comprising a plurality of teeth on each of the one or more gears, wherein the at least one wear indicating line is located on side surfaces of the plurality of the teeth.

3. The wind turbine of claim 1, wherein the at least one wear indicating line is comprised of a recessed groove.

4. The wind turbine of claim 3, wherein the at least one wear indicating line is segmented and comprised of a plurality of alternating grooved regions and flush regions.

5. The wind turbine of claim 1, wherein the at least one wear indicating line is comprised of a raised rib.

6. The wind turbine of claim 5, wherein the at least one wear indicating line is segmented and comprised of a plurality of alternating ribbed regions and flush regions.

7. The wind turbine of claim 1, wherein the at least one wear indicating line is comprised of a roughened surface.

8. The wind turbine of claim 1, wherein the at least one wear indicating line is comprised of at least one of:
a polished surface, a reflective surface, a fluorescent material, a phosphorescent material and a magnetic material.

9. The wind turbine of claim 1, wherein the at least one wear indicating line is comprised of at least two or more of:
a recessed groove, a raised rib, a roughened surface, a polished surface, a reflective surface, a fluorescent material, a phosphorescent material and a magnetic material.

10. The wind turbine of claim 1, wherein the at least one wear indicating line is spaced a predetermined distance from bearing surfaces of the one or more gears.

11. A gearbox for a wind turbine comprising:
one or more gears having at least one wear indicating line that facilitates identification of gear wear;
wherein the at least one wear indicating line is located on side surfaces of the one or more gears.

12. The gearbox of claim 11, further comprising a plurality of teeth on each of the one or more gears, wherein the at least one wear indicating line is located on side surfaces of the plurality of the teeth.

13. The gearbox of claim 11, wherein the at least one wear indicating line is comprised of recessed grooves.

14. The gearbox of claim 13, wherein the at least one wear indicating line is segmented and comprised of a plurality of alternating grooved regions and flush regions.

15. The gearbox of claim 11, wherein the at least one wear indicating line is comprised of raised ribs.

16. The gearbox of claim 15, wherein the at least one wear indicating line is segmented and comprised of a plurality of alternating ribbed regions and flush regions.

17. The gearbox of claim 11, wherein the at least one wear indicating line is comprised of a roughened surface.

18. The gearbox of claim 11, wherein the at least one wear indicating line is comprised of at least one:
a polished surface, a reflective surface, a fluorescent material, a phosphorescent material and a magnetic material.

19. The gearbox of claim 11, wherein the at least one wear indicating line is comprised of at least two or more of:
a recessed groove, a raised rib, a roughened surface, a polished surface, a reflective surface, a fluorescent material, a phosphorescent material and a magnetic material.

20. The gearbox of claim 11, wherein the at least one wear indicating line is spaced a predetermined distance from bearing surfaces of the one or more gears.
